(19) United States
(12) Patent Application Publication
(10) Pub. No.: US 2010/0027025 A1
(43) Pub. Date: Feb. 4, 2010

(54) OPTICAL PROBE AND OPTICAL TOMOGRAPHIC IMAGING APPARATUS

(76) Inventor: Koki NAKABAYASHI, Kanagawa-ken (JP)

Correspondence Address: BIRCH STEWART KOLASCH & BIRCH, PO BOX 747, FALLS CHURCH, VA, 22040-0747, US

(21) Appl. No.: 12/533,711

(22) Filed: Jul. 31, 2009

(30) Foreign Application Priority Data
Aug. 1, 2008 (JP) 199692/2008

(51) Int. Cl. G01B 9/02; G02B 6/36

(52) U.S. Cl. 356/482; 385/78

(57) ABSTRACT

An optical probe includes: an optical fiber; a substantially cylindrical ferrule integrally fixed to the optical fiber in the vicinity 2of the distal end of the fiber; a distal optical system for deflecting laser emitted from the optical fiber toward a subject to be measured; a holding portion for holding the distal optical system, the holding portion being supported by the ferrule rotatably about the optical axis of the optical fiber; a rotating oscillator slidably engaging with the outer circumferential surface of the ferrule; a driving unit for imparting oscillation in the direction of the optical axis to the rotating oscillator; and a coupling member for coupling the holding portion with the rotating oscillator elastically in the direction of the optical axis. The rotating oscillator rotates about the optical axis and reciprocates in the direction of the optical axis due to the oscillation applied from the driving unit.

### BACKGROUND OF THE INVENTION

1. Field of the Invention

The present invention relates to an optical probe of an optical tomographic imaging apparatus which acquires an optical tomographic image using an OCT (Optical Coherence Tomography) measurement technique, and an optical tomographic imaging apparatus to which the optical probe is applied. More particularly, the present invention relates to an optical probe including, at the distal end of the optical probe, a driving means to rotate a distal end optical system which deflects laser light toward a subject to be measured, and an optical tomographic imaging apparatus to which the optical probe is applied.

2. Description of the Related Art

As a method for acquiring a tomographic image of a subject to be measured, such as a living body tissue, a method to acquire a tomographic image using an OCT measurement technique has been proposed. An OCT measurement system is one of optical interferometers. In the OCT measurement system, low-coherent light emitted from a light source is divided into measurement light and reference light. The measurement light is applied to a subject to be measured, and then reflected light or backscattered light from the subject to be measured is combined with the reference light to acquire a tomographic image based on intensity of interference light between the reflected light and the reference light. Hereinafter, the reflected light and the backscattered light from the subject to be measured are collectively referred to as the reflected light.

The OCT measurement techniques are roughly classified into TD (Time Domain)-OCT measurement techniques and FD (Fourier Domain)-OCT measurement techniques.

In the TD-OCT measurement, the intensity of the interference light is measured while the optical path length of the reference light is changed, thereby acquiring an intensity distribution of the reflected light corresponding to depth-wise positions in the subject to be measured.

In the FD-OCT measurement, the optical path lengths of the reference light and the signal light are fixed, and the intensity of the interference light is measured with respect to spectral components of the light. Then, the thus acquired spectral interference intensity signal is subjected to frequency analysis, typically the Fourier transform, on a computer, thereby acquiring an intensity distribution of the reflected light corresponding to the depth-wise positions. Recently, the FD-OCT measurement is attracting attention since it does not require mechanical scanning on which the TD-OCT measurement relies, and therefore allows high speed measurement.

Typical systems that carry out the FD-OCT measurement include an SD (Spectral Domain)-OCT system and an SS (Swept Source)-OCT system.

The SD-OCT system uses wideband low-coherent light, and decomposes the interference light into optical frequency components with a spectral means. Then, intensity of the interference light corresponding to each optical frequency component is measured using a photodetector array, or the like, and the waveform of the thus obtained spectral interference is subjected to the Fourier transform analysis on a computer, thereby forming a tomographic image.

The SS-OCT system uses, as a light source, a laser with optical frequency thereof swept with time, and measures a time-domain waveform of a signal corresponding to temporal change of the optical frequency of the interference light. Then, the thus obtained spectral interference intensity signal is subjected to the Fourier transform on a computer, thereby forming a tomographic image.

Further, it has been known with the optical tomographic imaging apparatus using any of the above-described techniques to use an optical probe, which is combined with an endoscope to be applied to in-vivo measurement by inserting the optical probe through a forceps channel of the endoscope so that the optical probe emits laser light in the subject. In general, the optical probe includes a distal end portion to be inserted into a body cavity and a base portion which contains a driving means.

U.S. Pat. No. 5,305,759 (patent document 1) discloses an OCT optical probe that includes: an elongated sheath to be inserted into a subject; a flexible shaft disposed in the sheath; an optical fiber covered with the flexible shaft; a distal optical system fixed at a distal end of the flexible shaft, the distal optical system deflecting laser light emitted from the optical fiber toward a subject to be measured; and a motor disposed at a base portion, the motor rotating the flexible shaft to effect scanning with the laser light.

“In vivo three-dimensional microelectromechanical endoscopic swept source optical coherence tomography”, J. Su et al., Optics Express, Vol. 15, No. 16, pp. 10390-10396, 2007 (non-patent document 1) discloses, along with the development of MEMS (Micro Electro Mechanical Systems) techniques in recent years, an OCT optical probe that includes an MEMS motor disposed in the vicinity of the distal end of the optical probe, and a distal optical system fixed to the rotating shaft of the MEMS motor, so that the distal optical system is rotated to effect scanning with the laser light.

The optical probe disclosed in patent document 1, however, has a rotary joint between the distal end portion to be inserted into the body cavity and the base portion containing the driving unit. The rotary joint optically couples the optical fiber on the distal end portion side in the rotating state to the optical fiber on the base portion side, and the rotary joint may cause an optical loss due to positional misalignment between the optical axes of the fibers.

Further, since the optical probe disclosed in patent document 1 has a long distance between the distal end optical system and the driving means disposed at the base portion, measurement accuracy may be lowered due to uneven rotation caused by fluctuation of stress applied to the flexible shaft, friction between the sheath and the flexible shaft, etc.

In addition, in recent years, along with improvement of measurement accuracy, there are demands for diameter reduction of optical probes for use with optical tomographic imaging apparatuses.

The optical probe disclosed in non-patent document 1 uses an MEMS motor having a complicated structure. Therefore, it is difficult to address the demands for diameter reduction of the optical probes in recent years, and such an optical probe is expensive.

### SUMMARY OF THE INVENTION

In view of the above-described circumstances, the present invention is directed to reducing lowering of measurement accuracy by eliminating optical loss at a rotary joint and reducing uneven rotation, and to inexpensively accomplishing an optical probe which allows diameter reduction and an optical tomographic imaging apparatus.

In order to address the above-described problems, an aspect of the optical probe of the invention includes: an optical fiber; a substantially cylindrical ferrule integrally fixed to the optical fiber in the vicinity of a distal end of the optical fiber; a distal end optical system for deflecting laser light emitted from the optical fiber toward a subject to be measured; a holding portion for holding the distal end optical system, the holding portion being supported by the ferrule rotatably about an optical axis of the optical fiber; a rotating oscillator slidably engaging with an outer circumferential surface of the ferrule; a driving unit for imparting oscillation in the direction of the optical axis to the rotating oscillator; and a coupling member for coupling the holding portion with the rotating oscillator elastically in the direction of the optical axis, wherein the rotating oscillator rotates about the optical axis and reciprocates in the direction of the optical axis due to the oscillation applied from the driving unit.

The description “slidably engaging with an outer circumferential surface” herein refers to that the rotating oscillator not only slides in the direction of the optical axis on the outer circumferential surface, but also slides about the optical axis on the outer circumferential surface.

In the optical probe of the invention, the ferrule may include, on the outer circumferential surface thereof, a groove having a shape of a continuous wave formed in a circumferential direction, and the rotating oscillator may include protrusions to slide along the groove.

Alternatively, in the optical probe of the invention, the ferrule may include, on the outer circumferential surface thereof, a groove having a shape of a continuous wave formed in a circumferential direction, and the rotating oscillator may include bearing balls rolling along the groove and a hole containing the bearing balls.

The “shape of a continuous wave” herein refers to a shape of a wave without a discontinuous portion.

In the optical probe of the invention, when the continuous waveform is a sine wave and the rotating oscillator includes n protrusions sliding along the groove or n bearing balls rolling along the groove, the sine wave may have a phase variation of 2nmπ (m is a natural number) per circuit around the outer circumferential surface, and the protrusions or the bearing balls may travel in the same phase along the sine wave.

In the optical probe of the invention, when the continuous waveform is a sine wave, the rotating oscillator includes n protrusions or n bearing balls (n is two or more), and the groove includes H grooves (H is two or more), each sine wave may have a phase variation of 2nmπ/H (m is a natural number) per circuit around the outer circumferential surface, a phase difference between the sine waves may be a multiple of 2π/H, and the protrusions or the bearing balls may travel in the same phase along the sine waves.

In the optical probe of the invention, the groove maybe shaped to allow each bearing ball rolling in a predetermined direction to roll on one of side surfaces of the groove serving as a side surface for rolling, and then to roll on another side surface of the groove serving as the side surface for rolling when the bearing ball has passed through each inflection point, and a notch may be formed at a point before each inflection point in the side surface opposite to the side surface for rolling, the notch receiving the bearing ball when the bearing ball begins to roll in a opposite direction in the vicinity of the inflection point.

The “each inflection point” herein refers to each position where the inclination of the continuous waveform is zero, and specifically refers to each peak of the continuous waveform.

The optical tomographic imaging apparatus according to the invention is an optical tomographic imaging apparatus using any of the above-described measurement techniques, to which the optical probe according to the invention is applied. Namely, the optical tomographic imaging apparatus according to the invention includes: a light source for emitting laser light; a light dividing section for dividing the laser light emitted from the light source into measurement light and reference light; an optical probe for applying the measurement light to a subject to be measured; a combining section for combining the reference light with reflected light from the subject to be measured when the measurement light is applied to the subject to be measured; an interference light detecting unit for detecting interference light between the combined reflected light and reference light; and a tomographic image processing unit for detecting reflection intensities at a plurality of depth-wise positions of the subject to be measured based on frequency and intensity of the detected interference light, and acquiring a tomographic image of the subject to be measured based on the reflection intensities at the depth-wise positions, wherein the optical probe includes the optical probe of the invention.

### EFFECT OF THE INVENTION

The optical probe of the invention includes: an optical fiber; a substantially cylindrical ferrule integrally fixed to the optical fiber in the vicinity of a distal end of the optical fiber; a distal end optical system for deflecting laser light emitted from the optical fiber toward a subject to be measured; a holding portion for holding the distal end optical system, the holding portion being supported by the ferrule rotatably about an optical axis of the optical fiber; a rotating oscillator slidably engaging with an outer circumferential surface of the ferrule; a driving unit for imparting oscillation in the direction of the optical axis to the rotating oscillator; and a coupling member for coupling the holding portion with the rotating oscillator elastically in the direction of the optical axis, and the rotating oscillator rotates about the optical axis and reciprocates in the direction of the optical axis due to the oscillation applied from the driving unit. Since the holding portion holding the distal end optical system rotates about the optical axis without rotating the optical fiber, it is not necessary to provide a rotary joint between the distal end portion and the base portion.

Further, the driving unit can be disposed in the vicinity of the distal end optical system, and this reduces uneven rotation.

Moreover, since the driving unit can be formed by a simple device that generates simple oscillation in the direction of the optical axis LP, the driving unit can be formed inexpensively.

As described above, the optical probe of the invention is free of optical loss at a rotary joint, reduces lowering of measurement accuracy due to the uneven rotation, and inexpensively achieves diameter reduction of the optical probe.

The optical tomographic imaging apparatus of the invention, to which the optical probe of the invention is applied, also inexpensively achieves reduction of lowering of measurement accuracy due to the uneven rotation.

### BRIEF DESCRIPTION OF THE DRAWINGS

FIG. 1 is a diagram illustrating the schematic configuration of an optical tomographic imaging apparatus 100,

FIG. 2 is a schematic sectional view of a distal end portion 10,

FIG. 3 is a diagram illustrating the shape of a ferrule 13,

FIG. 4 is a schematic sectional view illustrating one embodiment of the distal end portion,

FIG. 5 is a diagram illustrating another shape of the ferrule 13,

FIG. 6 is a diagram illustrating yet another shape of the ferrule 13,

FIG. 7 is a diagram illustrating how bearing balls 41 roll along a sine wave groove 13d, and

FIG. 8 is a diagram illustrating the schematic configuration of a tomographic image processing means 150.

### DESCRIPTION OF THE PREFERRED EMBODIMENTS

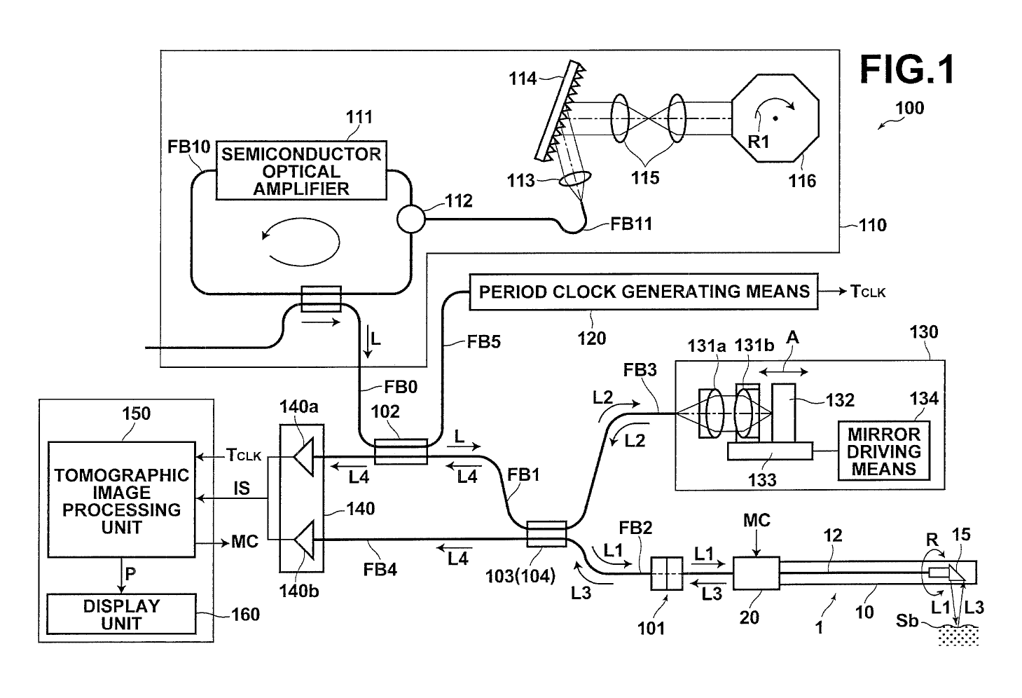

Hereinafter, an embodiment of an optical probe of the present invention and an embodiment of an optical tomographic imaging apparatus to which the optical probe of the invention is applied will be described with reference to the drawings. FIG. 1 is a diagram illustrating the schematic configuration of the optical tomographic imaging apparatus according to one embodiment of the invention. The optical tomographic imaging apparatus in this embodiment is an optical tomographic imaging apparatus which acquires an optical tomographic image using the SS-OCT measurement technique.

The optical tomographic imaging apparatus 100 includes: an optical probe 1 removably coupled to the apparatus 100 via a connector 101; a light source means 110 for emitting laser light L; an optical fiber coupler 102, which divides the laser light L emitted from the light source means 110; a period clock generating means 120, which outputs a period clock signal T_{CLK} from the laser light divided by the optical fiber coupler 102; a light dividing means 103, which divides one of the light beams of the laser light L divided by the optical fiber coupler 102 into measurement light L1 and reference light L2; an optical path length adjusting means 130, which adjusts the optical path length of the reference light L2 divided by the light dividing means 103; a combining means 104, which combines the reference light L2 with reflected light L3 that is reflected from a subject to be measured Sb when the measurement light L1 divided by the light dividing means 103 is applied from the optical probe 1 to the subject to be measured Sb; an interference light detecting means 140, which detects interference light L4 between the reflected light L3 and the reference light L2 combined by the combining means 104; and a tomographic image processing means 150, which applies frequency analysis to an interference signal IS fed from the interference signal detecting means 140 and acquires a tomographic image P of the subject to be measured Sb.

Now, the optical probe 1 is described. The optical probe 1 includes a distal end portion 10 to be inserted through a forceps channel of an endoscope (not shown), and a base portion 20.

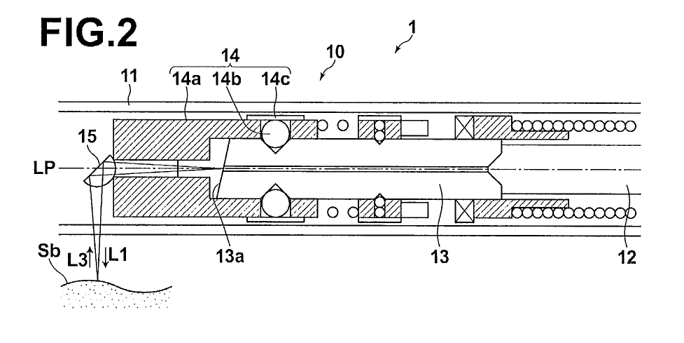

Application of the measurement light L1 from the optical probe 1 is described. FIG. 2 is a schematic sectional view of the distal end portion 10. As shown in FIG. 2, the distal end portion 10 of the OCT optical probe 1 includes: a substantially cylindrical flexible sheath 11; an optical fiber 12 contained in and extending along the longitudinal direction of the sheath 11; a ferrule 13 integrally fixed to the optical fiber 12 in the vicinity of the distal end of the optical fiber 12; a holding portion 14 supported by the ferrule 13 to be rotatable about an optical axis LP of the optical fiber 12; and a substantially hemispherical distal end optical system 15 held at the distal end of the holding portion 14. The distal end of the sheath 11 is closed with a cap (not shown).

The optical fiber 12 is inserted through the ferrule 13 to extend to the distal end surface 13a, and is fixed to the ferrule 13 with an adhesive, or the like. In this embodiment, the distal end surface 13a of the ferrule 13 is polished together with the optical fiber 12 at a predetermined inclination angle to reduce unnecessary reflected light at the distal end of the optical fiber 12. In this embodiment, the inclination angle is, for example, seven degrees from the direction perpendicular to the optical axis LP, based on APC (Angled PC) polishing standard, although this is not intended to limit the invention.

The distal end optical system 15 has a substantially hemispherical shape. The distal end optical system 15 deflects and collects the measurement light L1 emitted from the optical fiber 12 onto the subject to be measured Sb, and deflects and collects the reflected light L3 from the subject to be measured Sb onto the optical fiber 12. The focal distance of the distal end optical system 15 is, as one example, about 3 mm from the optical axis LP of the optical fiber 12 in the radial direction of the sheath 11. The measurement light L1 emitted from the distal end optical system 15 is inclined by an angle of about seven degrees from the direction perpendicular to the optical axis LP. The distal end optical system 15 is fixed to the holding portion 14 with an adhesive.

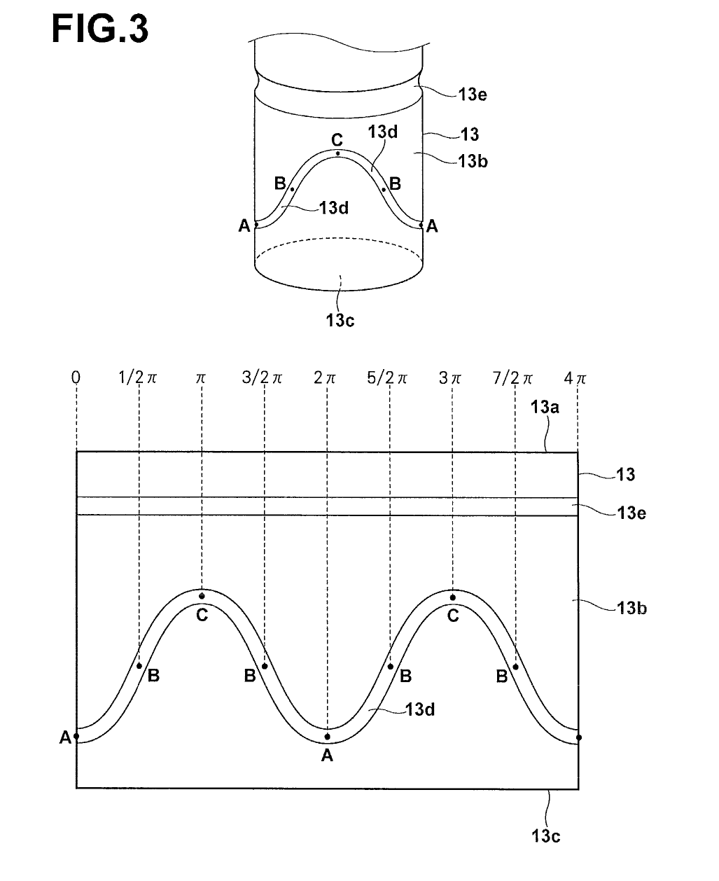

FIG. 3 is a diagram illustrating the shape of the ferrule 13. The upper part of FIG. 3 shows a perspective view of the ferrule 13, and the lower part of FIG. 3 shows a development view of an outer circumferential surface 13b of the ferrule 13. As shown in FIG. 3, the ferrule 13 includes a groove 13d having the shape of a continuous wave provided on the side near a base surface 13c of the outer circumferential surface 13b, and a groove 13e having the shape of a straight line provided on the side near the distal end surface 13a. In this embodiment, as one example, the groove 13d is a continuous groove having the shape of a sine wave, and is hereinafter referred to as a sine wave groove 13d, although this is not intended to limit the invention.

The sine wave groove 13d has a phase variation of 4π per circuit around the outer circumferential surface 13b, as one example. Positions A, B and C along the sine wave groove 13d indicate base positions, intermediate positions and distal positions of the sine wave groove 13d. The distance from the base surface 13c to the positions A is the same, and the same applies to the positions B and the positions C. In this embodiment, the positions A are at (0, 2π), the positions B are at (1/2π, 3/2π, 5/2π, 7/2π), and the positions C are at (π, 3π), as one example.

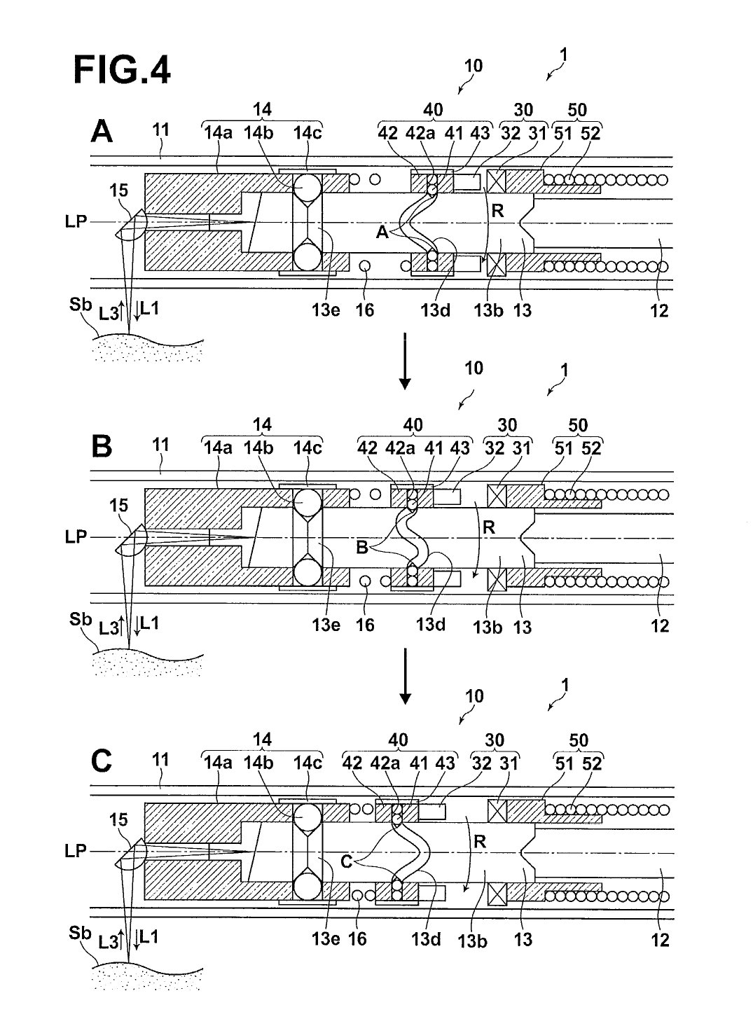

Next, the scanning with the measurement light L1 emitted from the optical probe 1 is described. FIG. 4 illustrates one embodiment of the distal end portion of the optical probe of the invention, and shows, respectively at “A”, “B” and “C” in the drawing, states in which bearing balls of a rotating oscillator, which will be described later, have passed the positions A, the positions B and the positions C on the sine wave groove 13d, which have been described with reference to FIG. 3.

The distal end portion 10 includes: a driving means 30, which generates oscillation in the direction of the optical axis LP to effect scanning with the measurement light L1 about the optical axis LP; a rotating oscillator 40, which rotates about the optical axis LP and reciprocates in the direction of the optical axis LP due to the oscillation applied from the driving means 30; a coupling member 16, which couples the holding portion 14 with the rotating oscillator 40 elastically in the direction of the optical axis LP; and a securing portion 50, which holds the ferrule 13.

The holding portion 14 includes: a holder 14a; bearing balls 14b, which roll along the groove 13e and are contained in a hole of the holder 14a; and a ring 14c, which prevents the bearing balls 14b from coming off. The holding portion 14 is held by the ferrule 13 rotationally about the optical axis LP via the bearing balls 14b rolling along the groove 13e.

The driving means 30 includes a magnet coil 31 fixed to the securing portion 50 and a magnet 32 fixed to the rotating oscillator 40. When the magnet coil 31 is excited, the magnet coil 31 and the magnet 32 reciprocate to move close to and apart from each other in the direction of the optical axis LP. If the ferrule 13 is formed of a magnetic material, an overlapping area between the magnetic field of the magnet 32 and the magnetic field induced by the magnet coil 31 is increased, thereby improving transmission efficiency.

The rotating oscillator 40 in this embodiment includes, as one example, bearing balls 41 disposed in positions having a phase difference of 2π along the sine wave groove 13d, a holder 42 having a hole 42a for containing the bearing balls 41, and a ring 43 for preventing the bearing balls 41 from coming off from the hole 42a. It should be noted that the rotating oscillator 40 is not limited to one described in this embodiment, and the rotating oscillator 40 may have a structure which includes protrusions to slide along the sine wave groove 13d.

The securing portion 50 includes a holder 51 for holding the ferrule 13, and a metal shaft 52 having one end thereof fixed to the holder 51 and the other end thereof fixed to the base portion 20 (not shown). As will be described later, the shaft 52 prevents the ferrule 13 and the optical fiber 12 from being twisted while the holding portion 14 and the rotating oscillator 40 rotate.

Next, the scanning with the measurement light L1 emitted from the distal end portion 10 is described with reference to FIG. 4. As described above, FIG. 4 shows, at “A”, a state where the bearing balls 41 are in the positions A on the sine wave groove 13d. When the magnet coil 31 is excited to generate a magnetic field in a direction in which the magnet coil 31 and the magnet 32 move apart from each other, the magnet 32 and the rotating oscillator 40 fixed to the magnet 32 move toward the distal end.

The bearing balls 41 start to roll from the positions A of the sine wave groove 13d, and the holder 42 and the ring 43 rotate in the direction of arrow R to move on the outer circumferential surface 13b toward the distal end. The movement of the rotating oscillator 40 in the direction of the optical axis LP is absorbed by flexing of the coupling member 16, and the rotation of the rotating oscillator 40 about the optical axis LP is transmitted to the holding portion 14 via the coupling member 16.

As the bearing balls 14b roll along the groove 13e, the holding portion 14 and the distal end optical system 15 held by the holding portion 14 rotate in the direction of arrow R. When the rotating oscillator 40 has rotated from the position shown at “A” in FIG. 4 by an amount of 1/2π, the bearing balls 41 reach the positions B of the sine wave groove 13d shown at “B” in FIG. 4. When the rotating oscillator 40 has rotated from the position shown at “A” in FIG. 4 by an amount of π, the bearing balls 41 reach the positions C of the sine wave groove 13d shown at “C” in FIG. 4.

When the excitation of the magnet coil 31 is switched to generate a magnetic field in a direction in which the magnet coil 31 and the magnet 32 move close to each other, the magnet 32 and the rotating oscillator 40 fixed to the magnet 32 move toward the base portion. In this manner, the bearing balls 41 continue to roll from the positions C of the sine wave groove 13d in the same direction, and the holding portion 14, the distal end optical system 15 and the rotating oscillator 40 rotate in the direction of arrow R. By repeatedly switching the excitation of the magnet coil 31, the holding portion 14, the distal end optical system 15 and the rotating oscillator 40 continue to rotate about the optical axis LP, and the distal end portion 10 moves the measurement light L1 to scan about the optical axis LP. As one example, the excitation of the magnet coil 31 is switched to rotate the measurement light L1 about the optical axis LP at a frequency of about 10 to 20 Hz.

Although the driving means 30 described in this embodiment is formed by the magnet coil 31 and the magnet 32, this is not intended to limit the invention. The driving means 30 may be formed by a piezoelectric oscillator using a piezoelectric device, or an electrostatic oscillation motor which oscillates when the direction of the electric field is switched.

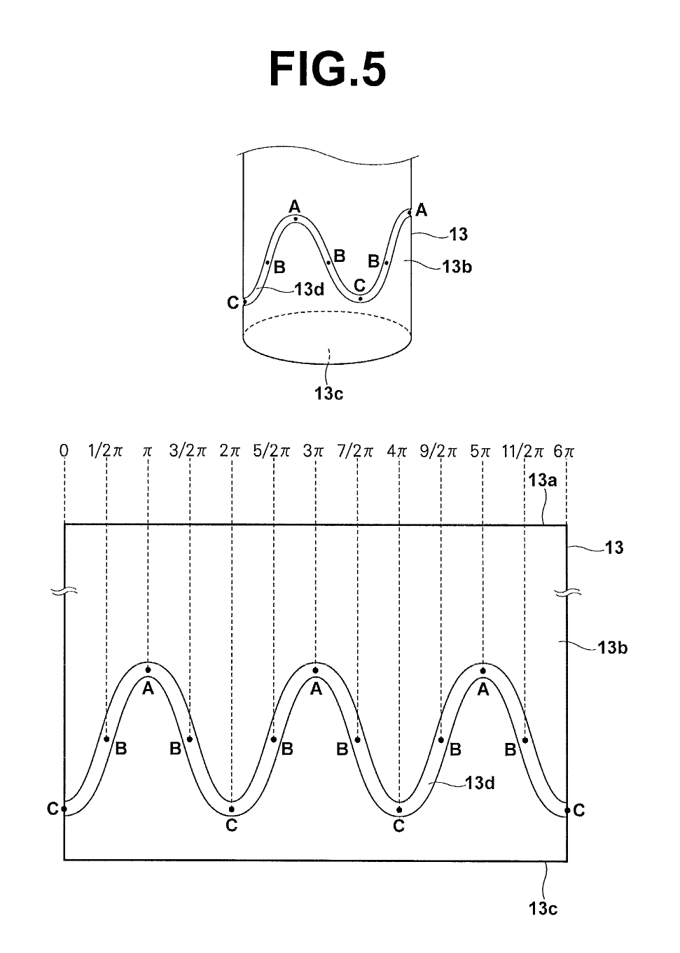

Increasing the number of the bearing balls 41 can stabilize the rotation and reciprocation of the rotating oscillator 40. FIG. 5 shows another shape of the ferrule 13 having the sine wave groove 13d when three bearing balls 41 are provided to roll along the sine wave groove 13d. Similarly to FIG. 3, the upper part of FIG. 5 shows a perspective view of the ferrule 13, and the lower part of FIG. 5 shows a development view of the outer circumferential surface 13b.

In the optical probe 1, in a case where n bearing balls 41 roll along a single sine wave groove 13d, the sine wave groove 13d is formed such that the sine wave has a phase variation of 2nmπ (m is a natural number)per circuit around the outer circumferential surface 13b. The bearing balls 41 travel in the same phase along the sine wave groove 13d.

By increasing the phase variation per circuit around the outer circumferential surface 13b, the number of scanning with the measurement light L1 about the optical axis LP while the rotating oscillator 40 rotate around the outer circumferential surface 13b once is increased, thereby improving scanning efficiency. Further, by increasing the phase variation per circuit around the outer circumferential surface 13b, the rotational angle for one reciprocation of the rotating oscillator 40 is decreased, and therefore the torque is relatively increased. While the increase of the torque allows rotation with lower energy, rotation speed decreases and machining of the groove becomes difficult. Therefore, it is necessary to design the groove with taking size, weight, friction coefficient, etc., into account.

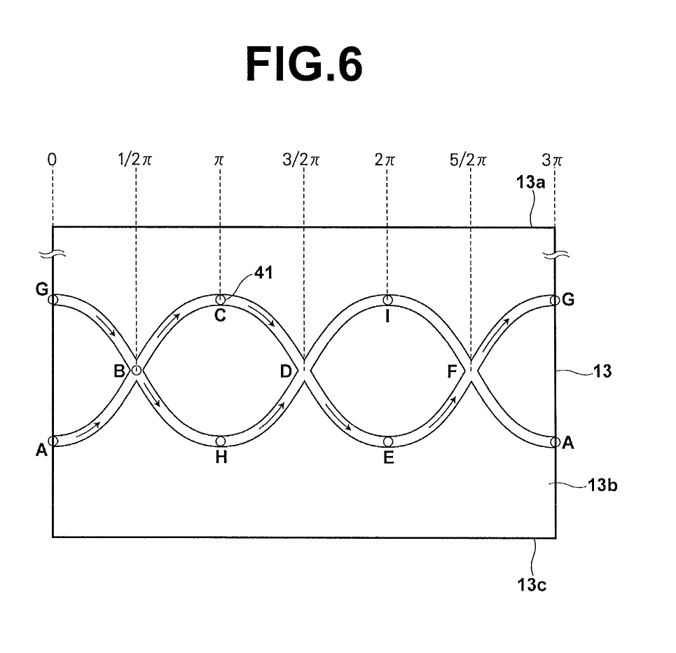

Increasing the phase variation of the sine wave per circuit around the outer circumferential surface 13b makes machining of the sine wave groove 13d difficult. FIG. 6 shows yet another shape of the ferrule 13 having two sine wave grooves 13d, where tree bearing balls roll along the sine wave grooves 13d. FIG. 6 is a development view of the outer circumferential surface 13b of the ferrule 13.

With reference to FIG. 6, how the bearing balls 41 roll is described. The three bearing balls 41 travel in the same phase along the sine waves. In this embodiment, as one example, the three bearing balls 41 are initially at positions A, E and H, respectively. For ease of understanding, the bearing ball at the position A is described.

As shown by the arrows in FIG. 6, the bearing ball 41 at the position A travels through the position B, the position C, the position D, the position E, the position F, the position G, the position B, the position H, the position D, the position I, the position F, in this order, and returns to the position A. That is, the bearing ball 41 rolls alternately along the two sine wave grooves 13d, and this allows decreasing the phase variation of the sine wave grooves 13d per circuit around the outer circumferential surface 13b even when the number of the bearing balls 41 is increased. Each bearing ball 41 which are initially at the position E and the position H rolls in the similar manner.

When n bearing balls 41 roll along H (H is two or more) sine wave grooves 13d, the bearing balls 41 travel 2nmπ along the sine wave grooves 13d while they travel H times around the outer circumferential surface 13b. Therefore, the phase variation of each sine wave groove 13d per circuit around the outer circumferential surface 13b is 2nmπ/H (m is a natural number), and a phase difference between the sine waves is a multiple of 2π/H. The bearing balls 41 travel in the same phase along the sine wave grooves 13d.

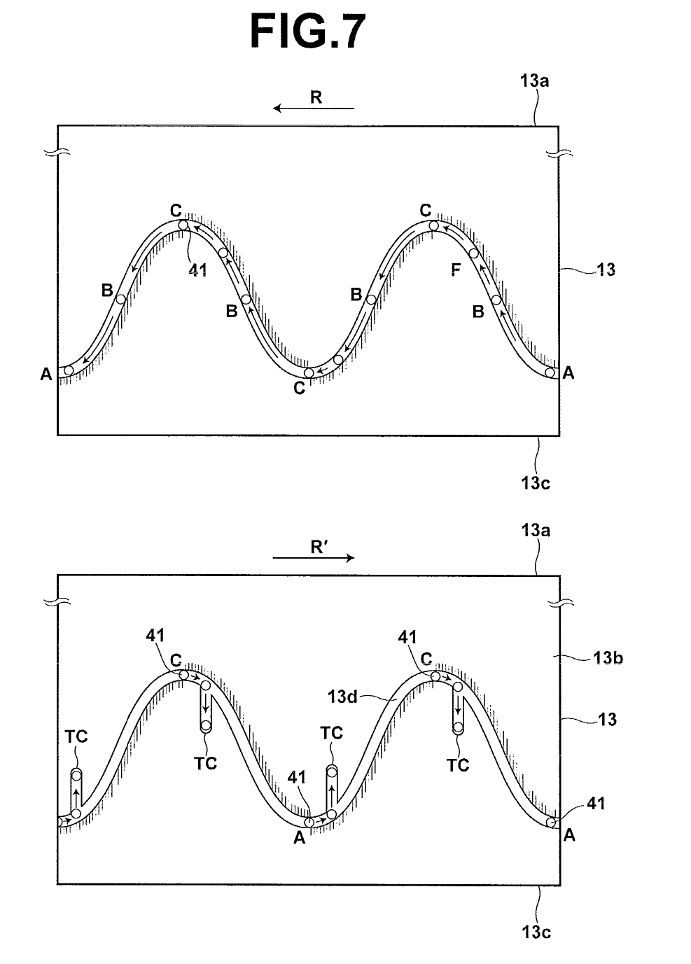

Each bearing ball 41 is pressed against one of the side surfaces of the sine wave groove 13d due to the oscillation applied from the driving means 30, and this side surface is referred to as a side surface for rolling, on which the bearing ball 41 rolls. FIG. 7 illustrates how the bearing balls 41 roll along the sine wave groove 13d. For ease of understanding, the description is given with referring each side surface with hatching, as shown in FIG. 7, as the side surface for rolling.

As shown at the upper part of FIG. 7, while the bearing ball 41 at the position A travels through the position B and reaches the position C, the bearing ball 41 rolls on the upper side surface of the sine wave groove 13d, i.e., the upper side surface serves as the side surface for rolling.

After the bearing ball 41 has passed through the position C, which is an inflection point where the inclination of the sine wave groove 13d is zero, the bearing ball 41 rolls on the opposite side surface (the lower side surface) of the sine wave groove 13d, i.e., the lower side surface serves as the side surface for rolling. It should be noted that, as the bearing balls 41 roll, the rotating oscillator 40 rotates in the direction of arrow R.

As shown at the lower part of FIG. 7, the optical probe 1 may include notches TC, each formed at a point before each inflection point in the side surface opposite to the side surface for rolling, so that the notches TC receive the bearing balls 41 in the event that the bearing balls 41 begin to roll in the opposite direction in the vicinity of the inflection points (the positions A and C), thereby preventing reverse rotation R′ of the rotating oscillator 40. It should be noted that, as mentioned above, the rotating oscillator 40 is not limited to one described in this embodiment, and the rotating oscillator 40 may have a structure which includes protrusions that slide along the sine wave groove 13d. Even with the rotating oscillator 40 including the protrusions, the reverse rotation R′ of the rotating oscillator 40 can be prevented by provision of the notches TC. That is, by providing the notches TC, each formed at a point before each inflection point in the side surface opposite to the side surface for rolling, the notches TC receive the protrusions in the event that the protrusions begin to slide in the opposite direction in the vicinity of the inflection points, thereby preventing the reverse rotation R′ of the rotating oscillator 40.

Referring again to FIG. 1, the light source means 110 emits the laser light L with the wavelengths thereof swept in a constant period T0. Specifically, the light source means 110 includes a semiconductor optical amplifier (semiconductor gain medium) 111 and an optical fiber FB10. The optical fiber FB10 is connected to opposite ends of the semiconductor optical amplifier 111. When a driving current is injected, the semiconductor optical amplifier 111 emits weak light to one end of the optical fiber FB10, and amplifies the incoming light from the other end of the optical fiber FB10. When the driving current is supplied to the semiconductor optical amplifier 111, this optical resonator formed by the semiconductor optical amplifier 111 and the optical fiber FB10 emits pulsed laser light L to an optical fiber FB0.

Further, a circulator 112 is coupled to the optical fiber FB10, so that a portion of light guided through the optical fiber FB10 is fed from the circulator 112 to an optical fiber FB11. The light emitted from the optical fiber FB11 travels through a collimator lens 113, a diffraction optical element 114 and an optical system 115, and is reflected by a rotating polygon mirror 116. The reflected light travels back through the optical system 115, the diffraction optical element 114 and the collimator lens 113, and re-enters the optical fiber FB11.

The rotating polygon mirror 116 rotates at a high speed, such as around 30,000 rpm, in the direction of arrow R1, and the angle of each reflection facet with respect to the optical axis of the optical system 115 changes during the rotation. Thus, among the spectral components of the light split by the diffraction optical element 114, only a component of a particular wavelength range returns to the optical fiber FB11. The wavelength of the light returning to the optical fiber FB11 is determined by an angle between the optical axis of the optical system 115 and the reflection facet. Then, the light of the particular wavelength range entering the optical fiber FB11 is fed from the circulator 112 to the optical fiber FB10. As a result, the laser light L of the particular wavelength range is emitted to the optical fiber FB0.

Therefore, while the rotating polygon mirror 116 rotates at a constant speed in the direction of arrow R1, the wavelength λ of the light re-entering the optical fiber FB11 changes with time in a constant period.

The light source means 110 emits the laser light L with the wavelength thereof swept from a minimum sweep wavelength λmin to a maximum sweep wavelength λmax in a constant period T0 (for example, about 50 μsec). The wavelength-swept laser light L is emitted to the optical fiber FB0, and the laser light L is branched at the optical fiber coupler 2 to optical fibers FB1 and FB5. The light fed to the optical fiber FB5 is guided to the period clock generating unit 120.

The period clock generating unit 120 feeds one period clock signal T_{CLK} to the tomographic image processing means 150 each time the wavelength of the laser light L emitted from the light source means 110 is swept for one period.

The light dividing means 103 is formed, for example, by a 2×2 optical fiber coupler, and divides the laser light L guided from the light source means 110 via the optical fiber FB1 into the measurement light L1 and the reference light L2. Two optical fibers FB2 and FB3 are optically connected to the light dividing means 103, so that the measurement light L1 is guided through the optical fiber FB2 and the reference light L2 is guided through the optical fiber FB3. It should be noted that the light dividing means 103 in this embodiment also serves as the combining means 104.

The optical path length adjusting unit 130 is disposed at the side of the optical fiber FB3 from which the reference light L2 is emitted. The optical path length adjusting unit 130 changes the optical path length of the reference light L2 to adjust the position at which acquisition of the tomographic image is started. The optical path length adjusting unit 130 includes: a reflection mirror 132, which reflects the reference light L2 emitted from the optical fiber FB3; a first optical lens 131a disposed between the reflection mirror 132 and the optical fiber FB3; and a second optical lens 131b disposed between the first optical lens 131a and the reflection mirror 132.

The reference light L2 emitted from the optical fiber FB3 is collimated by the first optical lens 131a and is collected by the second optical lens 131b onto the reflection mirror 132. Then, the reference light L2 reflected from the reflection mirror 132 is collimated by the second optical lens 131b and is collected by the first optical lens 131a onto the optical fiber FB3.

The optical path length adjusting unit 130 further includes: a base 133, on which the second optical lens 131b and the reflection mirror 132 are fixed; and a mirror moving means 134, which moves the base 133 along the optical axis of the first optical lens 131a. The optical path length of the reference light L2 is changed by moving the base 133 in the direction of arrow A.

The combining means 104 is formed by a 2×2 optical fiber coupler, as described above. The combining means 104 combines the reference light L2 having the optical path length adjusted by the optical path length adjusting means 130 with the reflected light L3 from the subject to be measured Sb, and feeds the combined light to the interference light detecting unit 140 via the optical fiber FB4.

The interference light detecting unit 140 detects the interference light L4 between the reflected light L3 and the reference light L2 combined by the combining means 4, and outputs the interference signal IS to the tomographic image processing means 150. It should be noted that, in this embodiment, the interference light L4 is divided into two parts at the light dividing means 3 and these parts are guided to the photodetectors 140a and 140b to be calculated to achieve balanced detection.

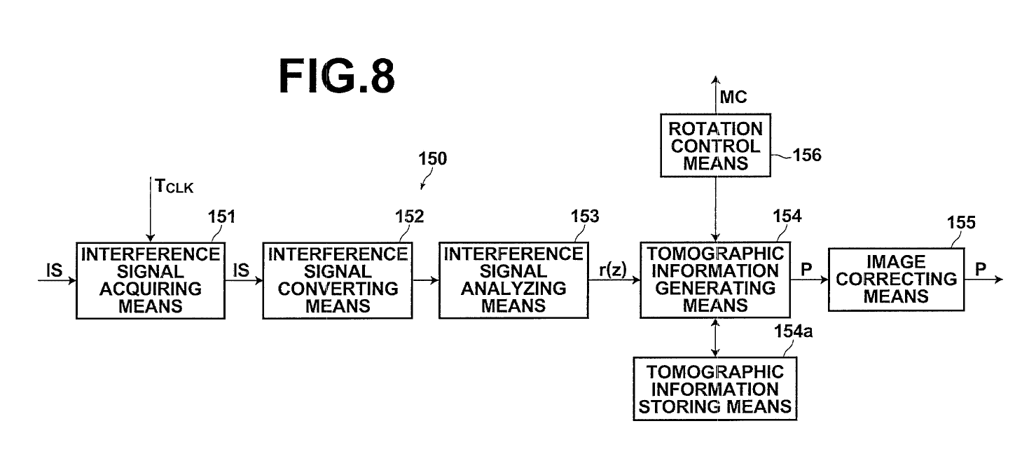

FIG. 8 is a diagram illustrating the schematic configuration of the tomographic image processing means 150. The tomographic image processing means 150 is implemented by executing on a computer a tomographic imaging program, which is installed in an auxiliary storage device of the computer. The tomographic image processing means 150 includes an interference signal acquiring means 151, an interference signal converting means 152, an interference signal analyzing means 153, a tomographic information generating means 154, an image correcting means 155 and a rotation control means 156.

The interference signal acquiring means 151 acquires the interference signal IS for one period, which is detected by the interference light detecting unit 140, based on the period clock signal T_{CLK} fed from the period clock generating means 120. The interference signal acquiring means 151 acquires the interference signal IS spanning between points before and after the output timing of the period clock signal T_{CLK} It should be noted that the output timing of the period clock signal T_{CLK} may be set immediately after the start of the wavelength sweeping or immediately before the end of the wavelength sweeping, as long as it is within the wavelength band to be swept, so that the interference signal acquiring means 151 can acquire the interference signal IS for one period based on the output timing of the period clock signal T_{CLK}.

The interference signal converting means 152 rearranges the interference signal IS acquired by the interference signal acquiring means 151 at equal intervals along a wavenumber k (=2π/λ) axis. Specifically, the interference signal converting means 152 is provided in advance with a time-to-wavelength sweep characteristics data table or function of the light source means 110, and uses this time-to-wavelength sweep characteristics data table or function to rearrange the interference signal IS at equal intervals along the wavenumber k axis. This allows acquisition of highly accurate tomographic information by using a spectral analysis technique that assumes that the data is arranged in equal intervals in a frequency space, such as the Fourier transform or processing using the maximum entropy method, when the tomographic information is calculated from the interference signal IS. Details of this signal conversion technique is disclosed in U.S. Pat. No. 5,956,355.

The interference signal analyzing means 153 acquires the tomographic information r(z) by applying a known spectral analysis technique, such as the Fourier transform, the maximum entropy method, or the Yule-Walker method, to the interference signal IS converted by the interference signal converting means 152.

The rotation control means 156 outputs the control signal MC for the driving means 30. Further, rotational angle information is fed from the base portion 20 to the rotation control means 156. Specifically, the rotational angle information can be acquired by proving a rotary encoder at the distal end optical system 15 and a linear encoder at the rotating oscillator 40, for example. It should be noted that the rotational angle information is not essential since the rotational angle can be estimated by regularly oscillating the rotating oscillator 40 at a constant frequency.

The tomographic information generating means 154 acquires the tomographic information r(z), which corresponds to scanning by the distal end portion 10 of the OCT optical probe 1 about the optical axis LP, for one period (one line) acquired by the interference signal analyzing means 153, and generates a tomographic image P. The tomographic information generating means 154 stores the tomographic information r(z) for one line, which is sequentially acquired, in a tomographic information storing means 154a. The tomographic information generating means 154 generates the tomographic image P by reading the tomographic information r(z) for n lines at a time from the tomographic information storing means 154a. Alternatively, the tomographic information generating means 154 may generate the tomographic image P by sequentially reading the tomographic information r(z) from the tomographic information storing means 154a.

The image quality correcting means 155 applies image processing, such as sharpness correction and smoothness correction, to the tomographic image P generated by the tomographic information generating means 154.

The displaying means 160 shown in FIG. 1 displays the tomographic image P, which has been subjected to the image processing, such as sharpness correction and smoothness correction, by the image quality correcting means 155.

As described above, in the optical probe 1, the oscillation applied from the driving means 30 makes the rotating oscillator 40, which slidably engages with the ferrule 13, reciprocate in the direction of the optical axis LP on the outer circumferential surface 13b and rotate about the optical axis LP, and the holding portion 14, which is coupled to the rotating oscillator 40 via the coupling member 16, rotate about the optical axis LP. It is therefore not necessary to provide a rotary joint between the distal end portion 10 and the base portion 20.

Further, the driving means 30 can be disposed in the vicinity of the distal end optical system 15, and this reduces uneven rotation, thereby reducing lowering of the measurement accuracy.

Since the driving means 30 is achieved by the rotating oscillator 40 which only oscillates in the direction of the optical axis LP, the structure of the driving means is simplified, and the diameter reduction can inexpensively be achieved.

The optical tomographic imaging apparatus 100, to which the optical probe 1 is applied, can also inexpensively achieve reduction of lowering of the measurement accuracy due to uneven rotation of the distal end optical system 15.

It should be noted that, although the optical tomographic imaging apparatus of this embodiment is described as an optical tomographic imaging apparatus which acquires optical tomographic images using the SS-OCT measurement technique, the optical probe of the invention is also applicable to optical tomographic imaging apparatuses which acquire optical tomographic images using the SD-OCT and TD-OCT measurement techniques.

What is claimed is:

1. An optical probe comprising:
an optical fiber;
a substantially cylindrical ferrule integrally fixed to the optical fiber in the vicinity of a distal end of the optical fiber;
a distal end optical system for deflecting laser light emitted from the optical fiber toward a subject to be measured;
a holding portion for holding the distal end optical system, the holding portion being supported by the ferrule rotatably about an optical axis of the optical fiber;
a rotating oscillator slidably engaging with an outer circumferential surface of the ferrule;
a driving unit for imparting oscillation in the direction of the optical axis to the rotating oscillator; and
a coupling member for coupling the holding portion with the rotating oscillator elastically in the direction of the optical axis, wherein the rotating oscillator rotates about the optical axis and reciprocates in the direction of the optical axis due to the oscillation applied from the driving unit.

2. The optical probe as claimed in claim 1, wherein the ferrule comprises, on the outer circumferential surface thereof, a groove having a shape of a continuous wave formed in a circumferential direction, and the rotating oscillator comprises protrusions to slide along the groove.

3. The optical probe as claimed in claim 1, wherein the ferrule comprises, on the outer circumferential surface thereof, a groove having a shape of a continuous wave formed in a circumferential direction, and the rotating oscillator comprises bearing balls rolling along the groove and a hole containing the bearing balls.

4. The optical probe as claimed in claim 2, wherein, when the continuous waveform is a sine wave and the rotating oscillator comprises n protrusions sliding along the groove, the sine wave has a phase variation of 2nmπ (m is a natural number) per circuit around the outer circumferential surface, and the protrusions travel in the same phase along the sine wave.

5. The optical probe as claimed in claim 3, wherein, when the continuous waveform is a sine wave and the rotating oscillator comprises n bearing balls rolling along the groove, the sine wave has a phase variation of 2nmπ (m is a natural number) per circuit around the outer circumferential surface, and the bearing balls travel in the same phase along the sine wave.

6. The optical probe as claimed in claim 2, wherein, when the continuous waveform is a sine wave, the rotating oscillator comprises n protrusions (n is two or more), and the groove comprises H grooves (H is two or more), each sine wave has a phase variation of 2nmπ/H (m is a natural number) per circuit around the outer circumferential surface, a phase difference between the sine waves is a multiple of 2π/H, and the protrusions travel in the same phase along the sine waves.

7. The optical probe as claimed in claim 3, wherein, when the continuous waveform is a sine wave, the rotating oscillator comprises n bearing balls (n is two or more), and the groove comprises H grooves (H is two or more), each sine wave has a phase variation of 2nmπ/H (m is a natural number) per circuit around the outer circumferential surface, a phase difference between the sine waves is a multiple of 2π/H, and the bearing balls travel in the same phase along the sine waves.

8. The optical probe as claimed in claim 2, wherein the groove is shaped to allow each protrusions sliding in a predetermined direction to slide on one of side surfaces of the groove serving as a side surface for sliding, and then to slide on another side surface of the groove serving as the side surface for sliding when the protrusion has passed through each inflection point, and a notch is formed at a point before each inflection point in the side surface opposite to the side surface for sliding, the notch receiving the protrusion when the protrusion begins to slide in a opposite direction in the vicinity of the inflection point.

9. The optical probe as claimed in claim 3, wherein the groove is shaped to allow each bearing ball rolling in a predetermined direction to roll on one of side surfaces of the groove serving as a side surface for rolling, and then to roll on another side surface of the groove serving as the side surface for rolling when the bearing ball has passed through each inflection point, and a notch is formed at a point before each inflection point in the side surface opposite to the side surface for rolling, the notch receiving the bearing ball when the bearing ball begins to roll in a opposite direction in the vicinity of the inflection point.

10. An optical tomographic imaging apparatus comprising:
a light source for emitting laser light;
a light dividing section for dividing the laser light emitted from the light source into measurement light and reference light;
an optical probe for applying the measurement light to a subject to be measured;
a combining section for combining the reference light with reflected light from the subject to be measured when the measurement light is applied to the subject to be measured;
an interference light detecting unit for detecting interference light between the combined reflected light and reference light; and
a tomographic image processing unit for detecting reflection intensities at a plurality of depth-wise positions of the subject to be measured based on frequency and intensity of the detected interference light, and acquiring a tomographic image of the subject to be measured based on the reflection intensities at the depth-wise positions,
wherein the optical probe comprises the optical probe as claimed in claim 1.
